(19) United States
(12) Patent Application Publication
(10) Pub. No.: US 2025/0386126 A1
(43) Pub. Date: Dec. 18, 2025

(54) VEHICLE LAMP AND VEHICLE INCLUDING THE SAME

(71) Applicant: HYUNDAI MOBIS CO., LTD., Seoul (KR)

(72) Inventor: Myeong Je KIM, Yongin-si (KR)

(73) Assignee: HYUNDAI MOBIS CO., LTD., Seoul (KR)

(21) Appl. No.: 19/033,761

(22) Filed: Jan. 22, 2025

(30) Foreign Application Priority Data
Jun. 12, 2024 (KR) 10-2024-0076540

(51) Int. Cl. H04R 1/02; F21S 41/29; F21S 41/40; F21S 43/27

(52) U.S. Cl. CPC H04R 1/025; F21S 41/29; F21S 41/40; F21S 43/27; H04R 2499/13

(57) ABSTRACT

A vehicle lamp including a housing including an accommodation space defined therein, the accommodation space being configured to accommodate a light source, an outer lens connected to one side of the housing, the outer lens being configured to cover the accommodation space, and a vibration part fixed to one of the housing and the outer lens, the vibration part being configured to generate vibration, the one of the housing and the outer lens, to which the vibration part is fixed including a mounting area on which the vibration part is mounted and a peripheral area extending from an edge of the mounting area, the peripheral area being configured to surround the mounting area, and the peripheral area includes a peripheral part having a surface, the surface being configured to protrude or be recessed with respect to the mounting area.

### CROSS-REFERENCE TO RELATED APPLICATION

This application claims the benefit under 35 USC § 119(a) of priority to Korean Patent Application No. 10-2024-0076540, filed in the Korean Intellectual Property Office on Jun. 12, 2024, the entire disclosure of which is incorporated herein by reference for all purposes.

### TECHNICAL FIELD

The present disclosure relates to a vehicle lamp and a vehicle including the same.

### BACKGROUND

Recently, as the demand for an entertainment function increases in addition to a function as a transportation mean required for a vehicle, the demand for an additional function in addition to simple lighting in the case of a lamp mounted on the vehicle is increasing. As an example, recently, a function capable of performing communication with the outside has been added to a vehicle lamp.

According to the related art, communication with the outside is performed through visual information such as a lighting image or a light distribution pattern of the vehicle lamp. Meanwhile, examples of a method of performing a communication function with the outside include a method of using auditory information such as sound in addition to a method using the visual information. However, according to the related art, in the case of the vehicle lamp, it is difficult to install a speaker for sound output in the vehicle lamp because a watertight structure is adopted to prevent moisture from filling an interior thereof.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a vehicle lamp including a housing including an accommodation space defined therein, the accommodation space being configured to accommodate a light source, an outer lens connected to one side of the housing, the outer lens being configured to cover the accommodation space, and a vibration part fixed to one of the housing and the outer lens, the vibration part being configured to generate vibration, the one of the housing and the outer lens, to which the vibration part is fixed including a mounting area on which the vibration part is mounted and a peripheral area extending from an edge of the mounting area, the peripheral area being configured to surround the mounting area, and the peripheral area includes a peripheral part having a surface, the surface being configured to protrude or be recessed with respect to the mounting area.

The peripheral part may include a predetermined peripheral portion formed on a predetermined peripheral area of the peripheral part, a first predetermined direction intersecting a surface of the predetermined peripheral area, and the predetermined peripheral portion may include a shape configured to protrude or be recessed and aligned in the first predetermined direction with respect to the surface of the predetermined peripheral area.

The surface of the predetermined peripheral portion may include a rib configured to protrude in a first direction in which the predetermined peripheral area faces the accommodation space.

The surface of the predetermined peripheral portion may be configured to form a groove, the groove having a shape recessed in a second direction in which the accommodation space faces the predetermined peripheral area.

The mounting area and the peripheral area may be provided in the outer lens, and the vibration part and the mounting area may be arranged to face each other in a third direction in which the housing the outer lens are connected.

The outer lens may include a transmissive area configured such that a light emitted from the light source passes therethrough and a light shielding area configured to prevent the light emitted from the light source from passing therethrough, the light shielding area may be provided with the mounting area and the peripheral area, and extending in a fourth direction intersecting the third direction, the transmissive area may be disposed on the light shielding area in a fifth direction intersecting the third direction and the fourth direction, and the vibration part may be configured to be wider in the fourth direction than a first width thereof in the fifth direction.

A second width of the peripheral part in the fifth direction may be smaller than or equal to a third width of the light shielding area in the fifth direction.

The vibration part may be located inside the peripheral part based on a case in which one side of the vibration part in the third direction is viewed in parallel to the third direction.

The peripheral part may include a closed curve shape configured to surround the vibration part.

At least a portion of the peripheral part may be spaced apart from the vibration part in a sixth direction intersecting the third direction.

The vibration part may include a piezoelectric element.

The vehicle lamp may include a connection part disposed in a boundary between the housing and the outer lens and configured to connect the housing and the outer lens to each other.

The connection part may include a hot melt adhesive.

In a general aspect, here is provided a vehicle including a vehicle body and a vehicle lamp mounted on the vehicle body, the vehicle lamp including a housing including an accommodation space defined therein, the accommodation space being configured to accommodate a light source, an outer lens connected to one side of the housing, the outer lens being configured to cover the accommodation space, and a vibration part fixed to one of the housing and the outer lens and configured to generate vibration, the one of the housing and the outer lens, to which the vibration part is fixed, including a mounting area on which the vibration part is mounted and a peripheral area extending from an edge of the mounting area, the peripheral area being configured to surround the mounting area, and the peripheral area includes a peripheral part having a surface, the surface being configured to protrude with respect to the mounting area.

The vehicle may include a coupling part configured to couple the vehicle lamp and the vehicle body to fix the vehicle lamp to the vehicle body and a vibration absorbing material disposed between the coupling part and the vehicle lamp, the vibration absorbing material may be configured to prevent the vibration generated in the vehicle lamp from being transmitted to the vehicle body.

A material of the vibration absorbing material may include a rubber material.

### BRIEF DESCRIPTION OF THE DRAWINGS

The above and other objects, features and advantages of the present disclosure will be more apparent from the following detailed description taken in conjunction with the accompanying drawings:

FIG. 1 is a cross-sectional view of a vehicle according to an embodiment of the present disclosure;

FIG. 2 is an exploded view illustrating a housing and an outer lens of a vehicle lamp according to the embodiment of the present disclosure;

FIG. 3 is an enlarged view of part ‘A’ of FIG. 2;

FIG. 4 is a view illustrating a peripheral part according to a modification of the embodiment of the present disclosure; and

FIG. 5 is a view illustrating a state in which a connection part is disposed at an edge of a housing according to the embodiment of the present disclosure.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Hereinafter, a vehicle 1 according to the present disclosure will be described with reference to the accompanying drawings.

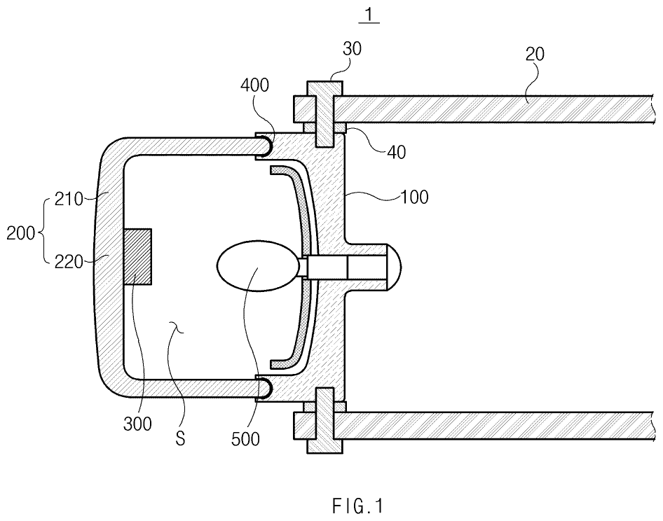

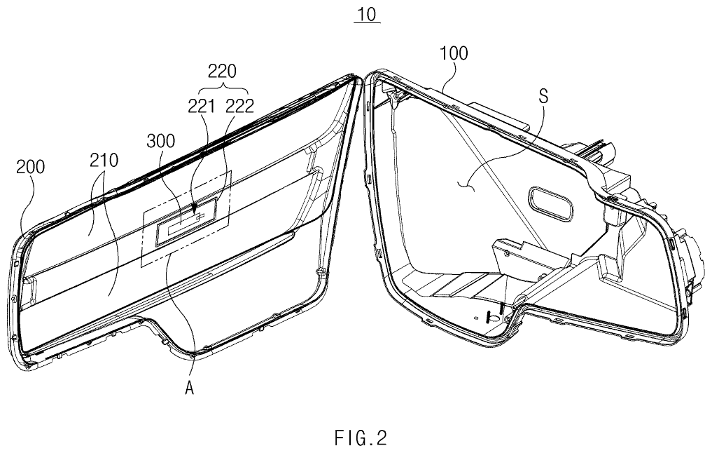

FIG. 1 is a cross-sectional view of a vehicle according to an embodiment of the present disclosure, and FIG. 2 is an exploded view illustrating a housing and an outer lens of a vehicle lamp according to the embodiment of the present disclosure.

Referring to FIGS. 1 and 2, the vehicle 1 may include a vehicle lamp 10 (hereinafter, referred to as a “lamp”), a vehicle body 20, a coupling part 30, and a vibration absorbing material 40. As an example, the lamp 10 may be provided as a head lamp or a rear lamp. The lamp 10 may form a predetermined light distribution pattern, a lighting image, and the like. Further, the lamp 10 may generate a sound. For example, the lamp 10 may output the sound to the outside through vibration of a housing 100 or an outer lens 200, which will be described below. The lamp 10 may include the housing 100, the outer lens 200, a vibration part 300, a connection part 400, and a light source 500.

The housing 100 may form at least a portion of an exterior of the lamp 10. An accommodation space “S” in which various components (e.g., the light source 500, a heat sink, a moisture absorbent, and the like) required for an operation of the lamp 10 may be accommodated may be formed inside the housing 100. The housing 100 may be fixed to the vehicle body 20.

The outer lens 200 may include a lens that guides a light emitted from the light source 500 to the outside of the vehicle 1. The outer lens 200 may form the exterior of the lamp 10 together with the housing 100. Further, the outer lens 200 may be provided to cover an accommodation space “S”. In other words, the accommodation space “S” may be a space defined by the housing 100 and the outer lens 200. The outer lens 200 may be connected to one side of the housing 100. For example, an edge of the outer lens 200 and an edge of the housing 100 may be connected to each other. A direction in which the edge of the outer lens 200 and the edge of the housing 100 face each other may be defined as a first direction. The outer lens 200 may include a light-transmissive area 210 and a light-shielding area 220.

The light-transmissive area 210 may mean an area through which the light emitted from the light source 500 is input, passes, and is then emitted. As an example, the light-transmissive area 210 may be formed of a transparent material. As an example, the light-transmissive area 210 may extend in a second direction intersecting the first direction. The second direction may be defined as a direction intersecting the first direction and perpendicular to a vertical direction (third direction). The light-transmissive area 210 may be provided as a plurality of light-transmissive areas 210. As an example, the plurality of light-transmissive areas 210 may be spaced apart from each other in the third direction with the light-shielding area 220 interposed therebetween.

The light-shielding area 220 may be provided to prevent the light emitted from the light source 500 from passing therethrough. For example, the light reaching the light-shielding area 220 may be prevented from being emitted to the outside of the vehicle 1. The light-shielding area 220 may extend in the second direction. The light-shielding area 220 may include a mounting area 221 and a peripheral area 222.

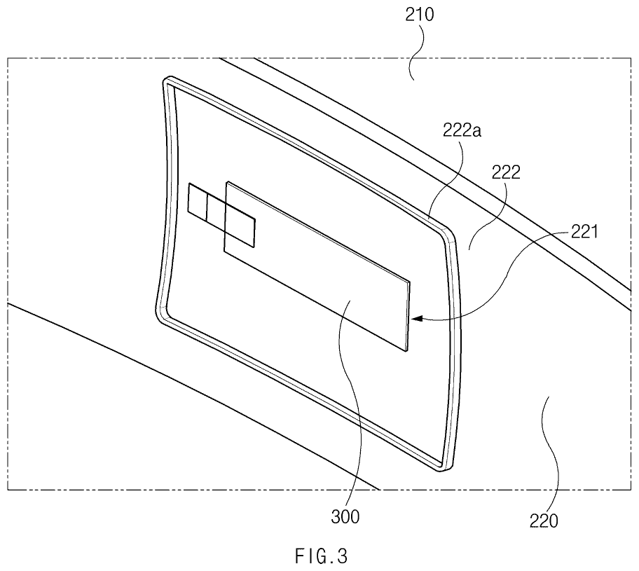

FIG. 3 is an enlarged view of part ‘A’ of FIG. 2.

Referring further to FIG. 3, the vibration part 300 may be mounted on the mounting area 221. The mounting area 221 may form a portion of an inner surface of the light-shielding area 220. The inner surface of the light-shielding area 220 may mean a surface of the light-shielding area 220 defining a portion of the accommodation space “S”. The mounting area 221 and the vibration part 300 may be arranged to face each other in the first direction.

The peripheral area 222 may mean an area located in a peripheral portion of the mounting area 221. The peripheral area 222 may be provided to surround the mounting area 221. The peripheral area 222 may extend from an edge of the mounting area 221. For example, the peripheral area 222 may extend from the edge of the mounting area 221 away from the mounting area 221. For example, the peripheral area 222 and the mounting area 221 may be integrally formed. The peripheral area 222 may include a peripheral part 222a.

The peripheral part 222a may have a surface protruding with respect to the mounting area 221. For example, the surface of the peripheral part 222a may have a shape protruding in a first predetermined direction with respect to the mounting area 221. When a portion of the peripheral part 222a is referred to as a predetermined peripheral portion, and a portion of the peripheral area 222 in which the predetermined peripheral portion is formed is referred to as a predetermined peripheral area, the first predetermined direction is defined as a direction intersecting a surface of the predetermined peripheral area. As a detailed example, the first predetermined direction may be defined as a direction perpendicular to the surface of the predetermined peripheral area. As a more detailed example, the first predetermined direction may be understood as a concept including a (1-1)^{th} predetermined direction that is a direction in which the mounting area 221 faces the vibration part 300 and a (1-2)^{th} predetermined direction opposite to the (1-1)^{th} predetermined direction.

A surface of the predetermined peripheral portion of the peripheral part 222a may have a rib shape protruding in a direction in which the predetermined peripheral area faces the accommodation space “S”. For example, the surface of the peripheral part 222a may be provided as a convex surface having a convex shape in the (1-1)^{th} predetermined direction with respect to the mounting area 221.

A width of the peripheral part 222a in the third direction may be formed to be smaller than or equal to a width of the light-shielding area 220 in the third direction. For example, when one side of the lamp 10 in the first direction is viewed parallel to the first direction, the peripheral part 222a may be disposed between an upper end and a lower end of the light-shielding area 220. As a detailed example, when the one side of the lamp 10 in the first direction is viewed parallel to the first direction, the peripheral part 222a may be located inside the light-shielding area 220.

A surface area of the peripheral area 222 may be greatly formed through the shape of the peripheral part 222a, and in this way, as the surface area of the peripheral area 222 is greatly formed, vibration energy of vibration generated by the vibration part 300 may be sufficiently consumed in the peripheral area 222. In this way, as the vibration energy of the vibration generated by the vibration part 300 is sufficiently consumed in the peripheral area 222, the vibration energy consumed in the remaining areas except for the mounting area 221 and the peripheral area 222 may be reduced. Further, as the vibration energy consumed in the remaining areas except for the mounting area 221 and the peripheral area 222 is reduced, the amount of vibration generated in the remaining areas may be minimized.

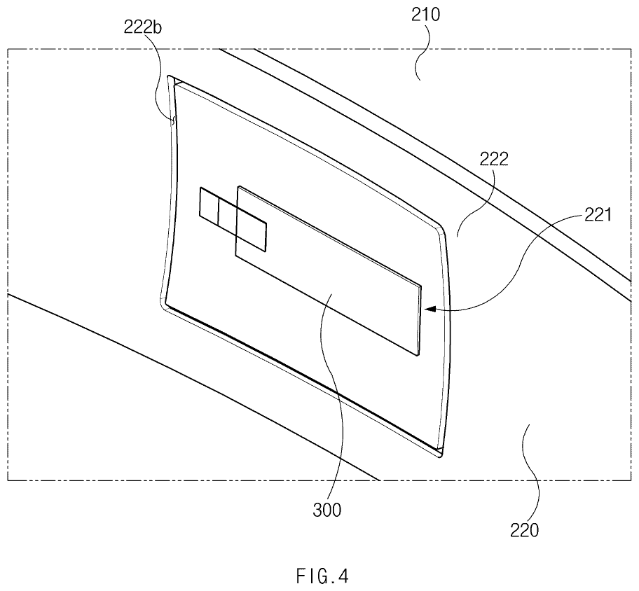

FIG. 4 is a view illustrating a peripheral part according to a modification of the embodiment of the present disclosure.

Meanwhile, the spirit of the present disclosure is not limited thereto, and referring to FIG. 4, the peripheral part 222b according to a modification of the embodiment of the present disclosure may form a groove having a shape indented in a direction in which the accommodation space “S” faces the predetermined peripheral area. For example, the surface of the peripheral part 222b may be provided as a concave surface having a concave shape in the (1-2)^{th} predetermined direction with respect to the mounting area 221. The groove formed by the peripheral part 222b may be defined by the concave surface.

Referring back to FIGS. 1 to 3, the vibration part 300 may generate vibration. The vibration part 300 may be fixed to one of the housing 100 and the outer lens 200. For example, the vibration part 300 may be mounted on the light-shielding area 220 to be fixed to the outer lens 200. As an example, the vibration part 300 may include a piezoelectric element. A piezoelectric element may mean an element having a property of generating a voltage when a mechanical stress is applied thereto and being contracted or expanded when a voltage is applied thereto.

A width of the vibration part 300 in the second direction is greater than a width thereof in the third direction. For example, the vibration part 300 may have a rectangular parallelepiped shape having a shape in which the width thereof in the second direction is greater than the width thereof in the third direction. However, the shape of the vibration part 300 is not limited to this example, and the vibration part 300 may be provided in various shapes (a multiple-column shape, a cylindrical shape, and the like) that may be surrounded by the peripheral part 222a.

The vibration part 300 may be located inside the peripheral part 222a based on a case in which one side of the vibration part 300 in the first direction is viewed in parallel to the first direction. As an example, the peripheral part 222a may have a closed curve shape surrounding the vibration part 300. In this way, as the peripheral part 222a has a closed curve shape surrounding the vibration part 300, all vibrations generated by the vibration part 300 may pass through the peripheral part 222a. As all the vibrations generated by the vibration part 300 pass through the peripheral part 222a, excessive vibration energy may be prevented from being transmitted to one of the remaining areas except for the mounting area 221 and the peripheral area 222.

Further, the vibration part 300 and the peripheral part 222a may be arranged to be spaced apart from each other in a direction (e.g., the second direction and the third direction) intersecting the first direction. For example, when the one side of the vibration part 300 in the first direction is viewed parallel to the first direction, an area between peripheries, which is a portion of the peripheral area 222, may be disposed between the vibration part 300 and the peripheral part 222a. As a detailed example, the vibration generated by the vibration part 300 may be attenuated while sequentially passing through the mounting area 221, the area between peripheries, and the peripheral part 222a.

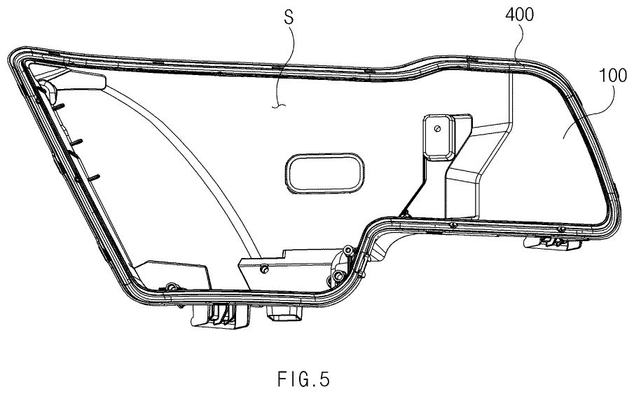

FIG. 5 is a view illustrating a state in which a connection part is disposed at an edge of a housing according to the embodiment of the present disclosure.

Referring further to FIG. 5, the connection part 400 may connect the housing 100 and the outer lens 200 to each other. The connection part 400 may be disposed at a boundary between the housing 100 and the outer lens 200. For example, the connection part 400 may be disposed between the edge of the housing 100 and the edge of the outer lens 200. As an example, the connection part 400 may include a hot melt adhesive.

Such a hot melt adhesive may be made of a material having elasticity. For example, the material of the hot melt adhesive may include a urethane material or a butyl material having a predetermined elastic modulus. Through such a hot melt adhesive, vibration generated in the outer lens 200 may be prevented from being transmitted to the housing 100. That is, the vibration generated in the outer lens 200 may be attenuated by the connection part 400 provided as the hot melt adhesive.

The vehicle body 20 may be a frame forming an exterior of the vehicle. The lamp 10 may be mounted on a front side or a rear side of the vehicle body 20. For example, when the lamp 10 is provided as a headlamp, the lamp 10 may be mounted on the front side of the vehicle body 20. Further, when the lamp 10 is provided as a rear lamp, the lamp 10 may be mounted on the rear side of the vehicle body 20.

Referring back to FIG. 1, the coupling part 30 may couple the lamp 10 and the vehicle body 20. As an example, the coupling part 30 may be provided as a bolt. As a detailed example, the coupling part 30 may be provided to pass through a coupling groove formed in the lamp 10 and a coupling groove formed in the vehicle body 20. The lamp 10 may be fixed to the vehicle body 20 through the coupling part 30.

The vibration absorbing material 40 may prevent vibration generated in the lamp 10 from being transmitted to the vehicle body 20. The vibration absorbing material 40 may be disposed between the coupling part 30 and the lamp 10. For example, referring to FIG. 1, the vibration absorbing material 40 may be disposed between the housing 100 of the lamp 10 and the vehicle body 20. Further, a hollow that may pass through the coupling part 30 may be formed in the vibration absorbing material 40. For example, the vibration absorbing material 40 may have a ring shape. As an example, a material of the vibration absorbing material 40 may include a rubber material.

According to the present disclosure, a function of outputting sound without affecting performance of a vehicle lamp may be added to the vehicle lamp.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A vehicle lamp, comprising:
a housing including an accommodation space defined therein, the accommodation space being configured to accommodate a light source;
an outer lens connected to one side of the housing, the outer lens being configured to cover the accommodation space; and
a vibration part fixed to one of the housing and the outer lens, the vibration part being configured to generate vibration,
wherein the one of the housing and the outer lens, to which the vibration part is fixed, comprises:
a mounting area on which the vibration part is mounted; and
a peripheral area extending from an edge of the mounting area, the peripheral area being configured to surround the mounting area, and
wherein the peripheral area includes a peripheral part having a surface, the surface being configured to protrude or be recessed with respect to the mounting area.

2. The vehicle lamp of claim 1, wherein the peripheral part comprises:
a predetermined peripheral portion formed on a predetermined peripheral area of the peripheral part,
wherein a first predetermined direction intersects a surface of the predetermined peripheral area, and
wherein the predetermined peripheral portion comprises:
a shape configured to protrude or be recessed and aligned in the first predetermined direction with respect to the surface of the predetermined peripheral area.

3. The vehicle lamp of claim 2, wherein the surface of the predetermined peripheral portion comprises:
a rib configured to protrude in a first direction in which the predetermined peripheral area faces the accommodation space.

4. The vehicle lamp of claim 2, wherein the surface of the predetermined peripheral portion is configured to form a groove, the groove having a shape recessed in a second direction in which the accommodation space faces the predetermined peripheral area.

5. The vehicle lamp of claim 1, wherein the mounting area and the peripheral area are provided in the outer lens, and
wherein the vibration part and the mounting area are arranged to face each other in a third direction in which the housing the outer lens are connected.

6. The vehicle lamp of claim 5, wherein the outer lens comprises:
a transmissive area configured such that a light emitted from the light source passes therethrough; and
a light shielding area configured to prevent the light emitted from the light source from passing therethrough, the light shielding area being provided with the mounting area and the peripheral area, and extending in a fourth direction intersecting the third direction,
wherein the transmissive area is disposed on the light shielding area in a fifth direction intersecting the third direction and the fourth direction, and
wherein the vibration part is configured to be wider in the fourth direction than a first width thereof in the fifth direction.

7. The vehicle lamp of claim 6, wherein a second width of the peripheral part in the fifth direction is smaller than or equal to a third width of the light shielding area in the fifth direction.

8. The vehicle lamp of claim 5, wherein the vibration part is located inside the peripheral part based on a case in which one side of the vibration part in the third direction is viewed in parallel to the third direction.

9. The vehicle lamp of claim 8, wherein the peripheral part includes a closed curve shape configured to surround the vibration part.

10. The vehicle lamp of claim 8, wherein at least a portion of the peripheral part is spaced apart from the vibration part in a sixth direction intersecting the third direction.

11. The vehicle lamp of claim 1, wherein the vibration part comprises:
a piezoelectric element.

12. The vehicle lamp of claim 1, further comprising:
a connection part disposed in a boundary between the housing and the outer lens and configured to connect the housing and the outer lens to each other.

13. The vehicle lamp of claim 12, wherein the connection part comprises:
a hot melt adhesive.

14. A vehicle, comprising:
a vehicle body; and
a vehicle lamp mounted on the vehicle body,
wherein the vehicle lamp includes:
a housing including an accommodation space defined therein, the accommodation space being configured to accommodate a light source;
an outer lens connected to one side of the housing, the outer lens being configured to cover the accommodation space; and
a vibration part fixed to one of the housing and the outer lens and configured to generate vibration,
wherein the one of the housing and the outer lens, to which the vibration part is fixed, comprises:
a mounting area on which the vibration part is mounted; and
a peripheral area extending from an edge of the mounting area, the peripheral area being configured to surround the mounting area, and
wherein the peripheral area includes a peripheral part having a surface, the surface being configured to protrude with respect to the mounting area.

15. The vehicle of claim 14, further comprising:
a coupling part configured to couple the vehicle lamp and the vehicle body to fix the vehicle lamp to the vehicle body; and
a vibration absorbing material disposed between the coupling part and the vehicle lamp, the vibration absorbing material being configured to prevent the vibration generated in the vehicle lamp from being transmitted to the vehicle body.

16. The vehicle of claim 15, wherein a material of the vibration absorbing material comprises:
a rubber material.
